(19) United States
(12) Patent Application Publication
(10) Pub. No.: US 2004/0233030 A1
(43) Pub. Date: Nov. 25, 2004

(54) Transformer

(76) Inventor: Albert Sullivan, Gary, IN (US)

Correspondence Address: Albert Sullivan, 2101 W 19th Avenue, Gary, IN, 46404, US

(21) Appl. No.: 10/129,991

(22) PCT Filed: Mar. 19, 2002
(86) PCT No.: PCT/US02/08492

Related U.S. Application Data
(63) Continuation-in-part of application No. 10/040,356, filed on Jan. 7, 2002, now abandoned.

(51) Int. Cl. H01F 27/28

(52) U.S. Cl. 336/182

(57) ABSTRACT

This transformer has improved cooling properties resulting in enhanced production of induced current.

### TECHNICAL FIELD

Energy

### BACKGROUND ART

Current models have poor cooling properties resulting in inefficient production of power

### DISCLOSURE OF INVENTION

The invention has improved cooling capabilities resulting in more efficient production of power.

### BRIEF DESCRIPTION OF DRAWINGS

None

### BEST MODE FOR CARRYING OUT THE INVENTION

This invention utilizes a hollow core instead of a solid core.

1. My claim is any hollow, composite core transformer used to produce induced power.
